(19) United States
(12) Patent Application Publication
(10) Pub. No.: US 2025/0201948 A1
(43) Pub. Date: Jun. 19, 2025

(54) Charging or Discharging Device

(71) Applicant: SK On Co., Ltd., Seoul (KR)

(72) Inventors: Chang Mook HWANG, Daejeon (KR); Myeong Seon KWON, Daejeon (KR); Ji Won NA, Daejeon (KR); Ha Neul SONG, Daejeon (KR)

(21) Appl. No.: 18/981,890

(22) Filed: Dec. 16, 2024

(30) Foreign Application Priority Data
Dec. 18, 2023 (KR) 10-2023-0184354

(51) Int. Cl. H01M 10/42

(52) U.S. Cl. CPC H01M 10/4285

(57) ABSTRACT

A charging or discharging device according to an embodiment of the present disclosure includes: a chamber including a charger/discharger capable of performing charging or discharging of a battery; and a gas detection portion formed on at least one surface of the chamber, wherein the gas detection portion includes: a venting hole through which a gas passes from the inside of the chamber; and a guide surrounding the venting hole and contacting with the gas discharged through the venting hole to vibrate the gas.

### CROSS-REFERENCE TO RELATED PATENT APPLICATION

The present application claims priority under 35 U.S.C. § 119 (a) to Korean patent application number 10-2023-0184354 filed on Dec. 18, 2023 in the Korean Intellectual Property Office, the entire disclosure of which is incorporated by reference herein.

### BACKGROUND OF THE INVENTION

### 1. Field

Embodiments of the present disclosure relate to a charging or discharging device.

### 2. Description of the Related Art

Batteries undergo a formation process during the manufacturing process. The formation process is a process in which charging or discharging of batteries are repeated several times to impart electrical characteristics to the batteries. The formation process is carried out by a charging or discharging device.

When charging or discharging are repeated, the temperature inside the chamber of a charging or discharging device performing charging or discharging may rapidly rise as a high-temperature gas is generated. Accordingly, a technology capable of early detecting the generation of a high-temperature gas is required.

### SUMMARY OF THE INVENTION

An embodiment of the present disclosure may provide a charging or discharging device capable of detecting the generation of a high-temperature gas.

Secondary batteries that are test targets of a charging or discharging device according to one embodiment of the present disclosure can be widely applied in the field of electric vehicles, battery charging stations, and green technology, such solar power generation, and wind power generation using batteries.

A charging or discharging device according to an embodiment of the present disclosure includes: a chamber including a charger/discharger capable of performing charging or discharging of a battery; and a gas detection portion formed on at least one surface of the chamber, wherein the gas detection portion includes: a venting hole through which a gas passes from the inside of the chamber; and a guide surrounding the venting hole and contacting with the gas discharged through the venting hole to vibrate the gas.

In one embodiment, the gas detection portion may generate a sound as the gas passes through the venting hole.

In one embodiment, the diameter of the venting hole may be 1 mm to 100 mm.

In one embodiment, the shape of the venting hole may be any one shape selected from the group consisting of a circular shape, an oval shape, a polygonal shape, a cross shape, a star shape, and an irregular shape.

In one embodiment, the shape of the venting hole may be a shape including a plurality of arms extending from the center of the above venting hole to the periphery of the venting hole.

In one embodiment, the width of the arms may decrease from the center of the venting hole to the periphery of the venting hole.

In one embodiment, the guide may include a material with a melting point higher than or equal to 60° C.

In one embodiment, the guide may include a material with a melting point of 80° C. to 200° C.

In one embodiment, the guide may include polyethylene.

In one embodiment, the gas detection portion may further include: a discharge hole through which a gas passing through the venting hole is discharged outside the chamber; and a cover connected to the discharge hole and capable of opening and closing the discharge hole.

In one embodiment, the cover may include: a first portion fixed in direct contact with a part of the periphery of the discharge hole; and a second portion connected to another part of the periphery of the discharge hole through a spring.

In one embodiment, the ratio of the diameter of the venting hole to the maximum diameter of the guide may be 1% to 50%.

In one embodiment, the distance from a point where the guide has the maximum diameter to the venting hole may be 10 mm to 1000 mm.

According to the present disclosure, a charging or discharging device capable of detecting the generation of a high-temperature gas can be provided.

### BRIEF DESCRIPTION OF THE DRAWINGS

FIG. 1 shows a diagram for explaining a charging or discharging device according to one embodiment of the present invention.

FIG. 2 shows a diagram for explaining in more detail an example of a gas detection portion of FIG. 1.

FIG. 3 shows a diagram for explaining in more detail an example of a cross-section of a venting hole of FIG. 2.

### DETAILED DESCRIPTION

The structural or functional descriptions of embodiments disclosed in the present specification or application are merely illustrated for the purpose of explaining embodiments according to the technical principle of the present invention, and embodiments according to the technical principle of the present invention may be implemented in various forms in addition to the embodiments disclosed in the specification of application. In addition, the technical principle of the present invention is not construed as being limited to the embodiments described in the present specification or application.

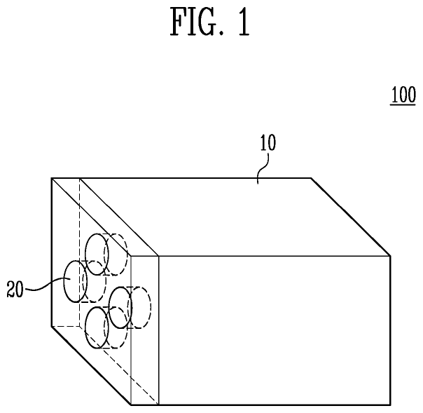

FIG. 1 shows a diagram for explaining a charging or discharging device according to one embodiment of the present invention.

Referring to FIG. 1, a charging or discharging device 100 includes a chamber 10. In an embodiment, a charging or discharging device 100 may include one or a plurality of chambers 10.

A chamber 10 may include a charger/discharger capable of performing charging or discharging for a battery. In an embodiment, a charger/discharger may adjust a charging current, a charging voltage, a discharging current, and/or a discharging voltage for a battery according to the preset voltage conditions and current conditions of a charging or discharging cycle, and may charge and discharge a battery connected as a test subject according to the preset conditions. In an embodiment, a charging or discharging device 100 may include one or more charger/dischargers, and each charger/discharger may be connected to one or more batteries. In an embodiment, a battery may generate a high-temperature gas during a charging or discharging process. In an embodiment, a battery may be a secondary battery that charges or discharges electric energy. A battery may include a cathode, an anode, an electrolyte, and a case that accommodates them. For example, a battery may be one of types classified into a lithium ion battery, a vanadium ion battery, an all-solid-state battery, a metal-air battery, a sodium ion battery, an aluminum ion battery, and the like depending on the material. As another example, a battery may be one of types such as pouch-type, prismatic type, and cylindrical type depending on the shape of the case.

In addition, a charging or discharging device 100 includes a gas detection portion 20. A gas detection portion 20 may be formed on at least one surface of a chamber 10. In an embodiment, a gas detection portion 20 may detect high-temperature gas generation occurring within a chamber 10. In an embodiment, a gas detection portion 20 may detect high-temperature gas generation by generating a sound when a high-temperature gas is generated.

In an embodiment, a high-temperature gas generated within a chamber 10 may be discharged outside the chamber 10 through a gas detection portion 20. In the process where a high-temperature gas is discharged outside a chamber 10, the high-temperature gas may pass through a gas detection portion 20, and when the high-temperature gas passes through the gas detection portion 20, a sound may be generated from the gas detection portion 20.

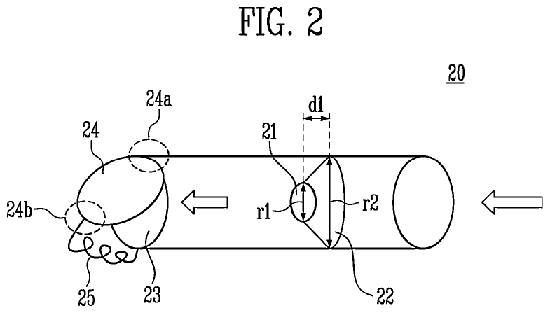

FIG. 2 shows a diagram for explaining in more detail an example of a gas detection portion of FIG. 1.

Referring to FIG. 2, a gas detection portion 20 may include a venting hole 21 and a guide 22 surrounding the venting hole. In other words, a guide 22 is formed while leaving some areas through which a gas may pass in the path through which the gas passes within the gas detection portion 20, and accordingly, some areas through which the gas may pass because a guide 22 is not formed may function as a venting hole 21.

In other words, a gas generated within a chamber 10 may pass through a venting hole 21. In the process where a gas passes through a venting hole 21, the gas may come into contact with a guide 22 around the venting hole 21. A gas that comes into contact with a guide 22 may vibrate, thereby generating a sound. The speed of a gas passing through a venting hole 21 may be 1 m/s to 100 m/s, more specifically, 2 m/s to 50 m/s, but is not limited thereto.

In an embodiment, the diameter (r1) of a venting hole 21 may be 1 mm to 100 mm, and more specifically, 5 mm to 90 mm. Here, the diameter of a venting hole may refer to the maximum value of the length of a straight line passing through the center point of the venting hole from one position on the edge of the venting hole to another position on the edge of the venting hole.

In one embodiment, the smaller the diameter of the venting hole 21, the higher the frequency of the sound may be generated. In an embodiment, the sound generated from a gas detection portion 20 may have a frequency within the human hearing range. For example, the frequency of the sound generated from a gas detection portion 20 may be in a range of 16 Hz to 20 KHz, and more specifically, 30 Hz to 19 KHz.

In an embodiment, the shape of the venting hole 21 may be any one shape selected from the group consisting of a circular shape, an oval shape, a polygonal shape, a cross shape, a star shape, and an irregular shape, but is not limited to a specific shape.

In an embodiment, a guide 22 may include a material with a melting point higher than or equal to 60° C., more specifically, 80° C. to 200° C. In one embodiment, a guide 22 may include polyethylene, but is not limited to a specific example.

In order for a gas detection portion 20 to detect a high-temperature gas, a guide 22 needs to maintain its shape without melting up to a certain temperature. Accordingly, a guide 22 may include a material with a melting point higher than or equal to 60° C., more specifically, 80° C.

In addition, in order for a gas detection portion 20 to detect gas generation in an early stage of high-temperature gas generation, it may be efficient that a sound is no longer generated at a temperature after a certain period of time has passed since the high-temperature gas was generated, that is, at a relatively higher temperature. Accordingly, a guide 22 may include a material with a melting point lower than or equal to 500° C., more specifically, lower than or equal to 200° C.

For example, when a guide 22 includes polyethylene having a melting point of about 137° C., the guide 22 may not change in shape at a temperature of about 100° C. at which a high-temperature gas is generated. Accordingly, a high-temperature gas generated at a temperature of about 100° C. at which a high-temperature gas is generated passes through a venting hole 21, and a sound may be generated by the high-temperature gas that has passed through the venting hole 21. When the temperature gradually rises after the high-temperature gas is generated and the temperature of the gas generated from the chamber far exceeds 137° C., which is the melting point of polyethylene, the guide 22 may melt, and as a result, the area of the venting hole 21 may gradually increase. When the size of the venting hole 21 becomes very large, a sound may not be generated even when the gas passes through the venting hole 21.

In an embodiment, since a guide 22 includes a material having a suitable range of melting point, a gas detection portion 20 may detect the occurrence of an event in an early stage of the event in which a high-temperature gas is generated, and accordingly, measures may be taken to prevent further temperature increase within the chamber.

In an embodiment, the maximum diameter (r2) of a guide 22 may be 3 mm to 1000 mm, and specifically 15 mm to 900 mm.

In an embodiment, the ratio (r1/r2) of the diameter (r1) of a venting hole 21 and the maximum diameter (r2) of a guide 22 may be from 1% to 50%. Specifically, it may be from 2% to 35%, more specifically, from 3% to 25%, and even more specifically, from 5% to 15%. Within the above-described r1/r2 range, a sound having a sufficiently large size to be recognized may be generated.

In an embodiment, the distance (d1) from the point where a guide 22 has the maximum diameter to a venting hole may be 10 mm to 1000 mm, specifically 15 mm to 500 mm, more specifically 20 mm to 180 mm, even more specifically 30 mm to 130 mm, and most specifically 70 mm to 120 mm.

In an embodiment, a gas detection portion 20 may further include a discharge hole 23. A gas passing through a venting hole may be discharged to the outside of a chamber through a discharge hole 23.

In an embodiment, a gas detection portion 20 may further include a cover 24. A cover 24 may be connected to a discharge hole 23, and the discharge hole 23 may be opened or closed through the cover 24. In one embodiment, when the pressure of a gas passing through a discharge hole 23 is higher than or equal to a preset value, a cover 24 may be opened so that the gas may be discharged to the outside through the discharge hole 23. In one embodiment, when the pressure of a gas passing through a discharge hole 23 is lower than a preset value, the discharge hole 23 may be closed by a cover 24 so that the gas may not be discharged to the outside.

In an embodiment, a cover 24 may include a first portion 24a that is fixed by directly contacting with a part of the periphery of a discharge hole 23. In other words, the first portion 24a may be in contact with the discharge hole 23 both when the cover 24 opens or closes the discharge hole 23.

In addition, a cover 24 may include a second portion 24b connected to another part of the periphery of a discharge hole 23. A second portion 24b may be in contact with a discharge hole 23 when a cover 24 closes the discharge hole 23, but may be spaced apart from the discharge hole 23 when the cover 24 opens the discharge hole 23. In other words, the cover 24 may move about the first portion 24a, which is fixed to discharge hole 23, as an axis, and thus the cover 24 may open or close the discharge hole 23.

In one embodiment, the second part 24b may be connected to another part of the periphery of the discharge hole 23 through a spring 25. In one embodiment, the pressure of a gas for opening a discharge hole 23 may be determined by adjusting the elastic modulus of the spring. When the pressure of a gas passing through a discharge hole 23 is higher than or equal to a preset value, the length of a spring 25 may be increased to open a cover 24. In one embodiment, when the pressure of a gas passing through a discharge hole 23 is lower than a preset value, a cover 24 may be closed as a spring 25 contracts again by a restoring force.

In one embodiment, a first part 24a may be positioned above a cover 24 based on the gravity direction, and a second part 24b may be positioned under the cover 24 based on the gravity direction. In this structure, even when a problem occurs in a spring 25 and the restoring force of the spring 25 is weakened, a cover 24 may be closed by gravity when the pressure of a gas passing through a discharge hole 23 is lower than a preset value.

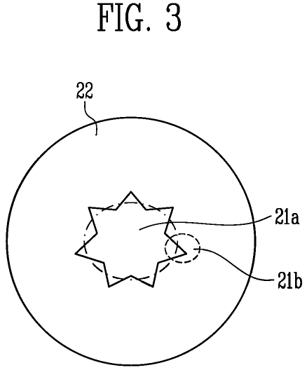

FIG. 3 shows a diagram for explaining in more detail an example of a cross-section of a venting hole of FIG. 2.

Referring to FIG. 3, a guide 22 may be positioned around a venting hole 21 having a specific shape. A venting hole 21 may include a central region 21a in the inside and one or more arms 21b extending from the central region 21a to the periphery of the venting hole 21.

Unlike a circular or oval shape, when the shape of a venting hole 21 include a central region 21a and arms 21b as shown in FIG. 3, there is an advantage in that the central region 21a allows a gas to pass smoothly while the arms 21b may easily generate a sound through their relatively small width.

In one embodiment, the width of arms 21b may decrease from the center of a venting hole to the periphery of the venting hole. Accordingly, the arms 21b may generate a sound more easily. In addition, as the number of arms 212b increases, a sound may be generated more easily. As an example of such a venting hole shape, a venting hole 21 may have a star shape as shown in FIG. 3, but is not limited thereto.

Hereinafter, embodiments of the present invention will be further described with reference to specific experimental examples. The examples and comparative examples included in the experimental examples are only illustrative of the present invention and do not limit the scope of the appended claims. It will be apparent to those skilled in the art that various changes and modifications to the embodiments are possible within the scope and technical idea of the present invention, and it is obvious that such changes and modifications fall within the scope of the appended claims.

### Example 1

A venting hole having a circular shape was formed using a polyethylene material as a guide. At this time, a gas detection portion and a charging or discharging device including the same were manufactured so that the diameter of the venting hole (r1) was 15.7 mm, the maximum diameter of the guide (r2) was 157.0 mm, and the distance from the point where the guide has the maximum diameter to the venting hole (d1) was 100 mm.

### Example 2

A venting hole having a circular shape was formed using a polyethylene material as a guide. At this time, a gas detection portion and a charging or discharging device including the same were manufactured so that the diameter of the venting hole (r1) was 31.4 mm, the maximum diameter of the guide (r2) was 157.0 mm, and the distance from the point where the guide has the maximum diameter to the venting hole (d1) was 100 mm.

### Example 3

A venting hole having a circular shape was formed using a polyethylene material as a guide. At this time, a gas detection portion and a charging or discharging device including the same were manufactured so that the diameter of the venting hole (r1) was 62.8 mm, the maximum diameter of the guide (r2) was 157.0 mm, and the distance from the point where the guide has the maximum diameter to the venting hole (d1) was 100 mm.

### Example 4

A venting hole having a circular shape was formed using a polyethylene material as a guide. At this time, a gas detection portion and a charging or discharging device including the same were manufactured so that the diameter of the venting hole (r1) was 94.2 mm, the maximum diameter of the guide (r2) was 157.0 mm, and the distance from the point where the guide has the maximum diameter to the venting hole (d1) was 100 mm.

### Example 5

A venting hole having a circular shape was formed using a polyethylene material as a guide. At this time, a gas detection portion and a charging or discharging device including the same were manufactured so that the diameter of the venting hole (r1) was 15.7 mm, the maximum diameter of the guide (r2) was 157.0 mm, and the distance from the point where the guide has the maximum diameter to the venting hole (d1) was 150 mm.

### Example 6

A venting hole having a circular shape was formed using a polyethylene material as a guide. At this time, a gas detection portion and a charging or discharging device including the same were manufactured so that the diameter of the venting hole (r1) was 15.7 mm, the maximum diameter of the guide (r2) was 157.0 mm, and the distance from the point where the guide has the maximum diameter to the venting hole (d1) was 200 mm.

### Example 7

A venting hole having a circular shape was formed using a polyethylene material as a guide. At this time, a gas detection portion and a charging or discharging device including the same were manufactured so that the diameter of the venting hole (r1) was 15.7 mm, the maximum diameter of the guide (r2) was 157.0 mm, and the distance from the point where the guide has the maximum diameter to the venting hole (d1) was 50 mm.

### Example 8

A venting hole having a star shape was formed using a polyethylene material as a guide. At this time, a gas detection portion and a charging or discharging device including the same were manufactured so that the diameter of the venting hole (r1), that is, the maximum distance from one vertex from the star shape to another vertex, was 15.7 mm, the maximum diameter of the guide (r2) was 157.0 mm, and the distance from the point where the guide has the maximum diameter to the venting hole (d1) was 100 mm.

### Experimental Example

After disposing a battery in the charging or discharging devices manufactured through Examples 1 to 8, charging or discharging were repeated. A high-temperature gas was discharged from the battery through repeated charging or discharging, and the size of the sound generated from the gas detection portion included in each charging or discharging device was measured, and the results are shown in Table 1 below.

TABLE 1

| | | | | | Distance | |
|---|---|---|---|---|---|---|
| | | Venting | Guide | | from | |
| | | hole | maximum | | guide to | Volume |
| | | diameter | diameter | | venting | of |
| | Shape | (r1) | (r2) | r1/r2 | hole (d1) | sound |
| Example 1 | Circular | 15.7 mm | 157 nm | 10% | 100 nm | 80 dB |
| Example 2 | Circular | 31.4 mm | 157 nm | 20% | 100 nm | 50 dB |
| Example 3 | Circular | 62.8 mm | 157 nm | 30% | 100 nm | 35 dB |
| Example 4 | Circular | 94.2 mm | 157 nm | 40% | 100 nm | 35 dB |
| Example 5 | Circular | 15.7 mm | 157 nm | 10% | 150 nm | 70 dB |
| Example 6 | Circular | 15.7 mm | 157 nm | 10% | 200 nm | 65 dB |
| Example 7 | Circular | 15.7 mm | 157 nm | 10% | 50 nm | 75 dB |
| Example 8 | Star | 15.7 mm | 157 nm | 10% | 100 nm | 75 dB |

Referring to Table 1, when Examples 1 to 4 are compared, it can be seen that Example 1, which had the smallest r1/r2 value, produced a louder sound than Examples 2 to 4, which had relatively large r1/r2 values.

In addition, when Example 1 and Examples 5 to 7 are compared, it can be seen that Example 1, which had d1 of 100 mm, produced a louder sound than Examples 5 to 7, which had d1 smaller or larger than that. In addition, it can be seen that as d1 increase, a louder sound was produced, and when d1 exceeded 100 mm, the sound volume rather decreased.

In addition, when Example 1 and Example 8 are compared, it can be seen that Example 8, which had a venting hole of a star shape, produced a louder sound than Example 1, which had a venting hole of a circular shape, under the same conditions.

What is claimed is:

1. A charging or discharging device comprising:
a chamber including a charger/discharger capable of performing charging or discharging of a battery; and
a gas detection portion formed on at least one surface of the chamber,
wherein the gas detection portion includes:
a venting hole through which a gas passes from the inside of the chamber; and
a guide surrounding the venting hole and contacting with the gas discharged through the venting hole to vibrate the gas.

2. The charging or discharging device according to claim 1, wherein the gas detection portion generates a sound as the gas passes through the venting hole.

3. The charging or discharging device according to claim 1, wherein the diameter of the venting hole is 1 mm to 100 mm.

4. The charging or discharging device according to claim 1, wherein the shape of the venting hole is any one shape selected from the group consisting of a circular shape, an oval shape, a polygonal shape, a cross shape, a star shape, and an irregular shape.

5. The charging or discharging device according to claim 4, wherein the shape of the venting hole is a shape including a plurality of arms extending from the center of the above venting hole to the periphery of the venting hole.

6. The charging or discharging device according to claim 5, wherein the width of the arms decreases from the center of the venting hole to the periphery of the venting hole.

7. The charging or discharging device according to claim 1, wherein the guide includes a material with a melting point higher than or equal to 60° C.

8. The charging or discharging device according to claim 6, wherein the guide includes a material with a melting point of 80° C. to 200° C.

9. The charging or discharging device according to claim 8, wherein the guide includes polyethylene.

10. The charging or discharging device according to claim 1, wherein the gas detection portion further includes:
a discharge hole through which a gas passing through the venting hole is discharged outside the chamber; and
a cover connected to the discharge hole and capable of opening and closing the discharge hole.

11. The charging or discharging device according to claim 10, wherein the cover includes:
a first portion fixed in direct contact with a part of the periphery of the discharge hole; and
a second portion connected to another part of the periphery of the discharge hole through a spring.

12. The charging or discharging device according to claim 1, wherein the ratio of the diameter of the venting hole to the maximum diameter of the guide is 1% to 50%.

13. The charging or discharging device according to claim 1, wherein the distance from a point where the guide has the maximum diameter to the venting hole is 10 mm to 1000 mm.
